(19) United States
(12) Patent Application Publication
(10) Pub. No.: US 2010/0306357 A1
(43) Pub. Date: Dec. 2, 2010

(54) SERVER, COMPUTER SYSTEM, AND METHOD FOR MONITORING COMPUTER SYSTEM

(75) Inventor: Jung-Tso Chen, Changhua County (TW)

Correspondence Address: Chen Yoshimura LLP;Attention Ying Chen, 333 W. El Camino Real, Suite 380, Sunnyvale, CA, 94087, US

(73) Assignee: ATEN INTERNATIONAL CO., LTD., Taipei County (TW)

(21) Appl. No.: 12/472,492

(22) Filed: May 27, 2009

(51) Int. Cl. G06F 15/16; G06F 9/46; G06F 9/445

(52) U.S. Cl. 709/223; 718/100; 713/1

(57) ABSTRACT

A server, a computer system and a method for monitoring the computer system are provided. The computer system includes the server and a remote computer. The server includes a basic input/output system (BIOS) and a base management controller (BMC). The remote computer includes a processing unit. The BIOS executes a detection procedure to generate a status code, and the BMC outputs a management message according to the status code. The processing unit executes monitor software such that the processing unit generates a monitor message according to the management message.

### BACKGROUND OF THE INVENTION

1. Field of the Invention

The invention relates in general to a server, a computer system and a method for monitoring the computer system, and more particularly to a server, a computer system and a method of monitoring a booting status of the computer system without the need of a debug card.

2. Description of the Related Art

A basic input/output system (BIOS) is in charge of initializing and testing various hardware apparatuses of a computer system to ensure the system to work normally. If the hardware apparatus is abnormal, the work may be stopped immediately and induced a message of the error apparatus fed back to a client. After the computer is powered on, the BIOS executes a detection procedure to check and test all the apparatuses, including a central processing unit (CPU), a memory, a read only memory (ROM), a system mainboard, a floppy drive and hard drive sub-system and a keyboard, in the computer. After the detection procedure is finished, the system searches for an operation system in a designated drive, and loads the operation system into the memory.

A power on self test (POST) code is generated when the BIOS executes the detection procedure. In the prior art, the user has to additionally purchase a debug card to monitor a booting status of the computer in order to obtain the POST code. After the debug card reads the POST code, a seven-segment display is adopted to display the POST code to the client. Then the client can realize the booting status corresponding to the POST code shown based on a look-up table listing definitions for all POST codes.

However, there are several hundreds or thousands of servers in a control room. So, if there are many servers need to be booted, even the management information system (MIS) operator managing the servers can obtain a lot of the debug cards one time, enormous labor cannot be avoided. They have to look up the look-up table one by one manually in order to obtain the current booting status of a current server. If the quantity of the debug cards is few, they further need to repeatedly plug in and remove the debug cards from each server to be booted. Moreover, if the servers have different BIOSs, the MIS operator has to obtain the current booting statuses of the servers according to different look-up tables.

### SUMMARY OF THE INVENTION

The invention is directed to a server, a computer system and a method for controlling the computer system.

According to a first aspect of the present invention, a computer system including a server and a remote computer is provided. The server includes a basic input/output system (BIOS) and a base management controller (BMC), and the remote computer includes a processing unit. The BIOS executes a detection procedure to generate a status code, and the BMC outputs a management message according to the status code. The processing unit executes monitor software such that the processing unit generates a monitor message according to the management message.

According to a second aspect of the present invention, a server including a BIOS and a BMC is provided. The BIOS executes a detection procedure to generate a status code, while the BMC outputs a management message according to the status code.

According to a third aspect of the present invention, a monitoring method of a computer system is provided. The method includes the steps of: executing a detection procedure to generate a status code; and controlling a BMC of a server to output a management message according to the status code.

The invention will become apparent from the following detailed description of the preferred but non-limiting embodiments. The following description is made with reference to the accompanying drawings.

### BRIEF DESCRIPTION OF THE DRAWINGS

FIG. 1 shows a computer system according to an embodiment of the invention.

FIG. 2 is a schematic illustration showing a server according to the embodiment of the invention.

FIG. 3 is a schematic illustration showing a remote computer according to the embodiment of the invention.

FIG. 4 is a schematic illustration showing the BMC for passively obtaining the status code according to a preferred embodiment of the invention.

FIG. 5 is a schematic illustration showing the BMC for actively obtaining the status code according to a preferred embodiment of the invention.

FIG. 6 is a schematic illustration showing the BMC for actively obtaining the status code according to a preferred embodiment of the invention.

FIG. 7 is a schematic illustration showing the CPU for acquiring the BIOS identifier from the BIOS according to a preferred embodiment of the invention.

FIG. 8 is a schematic illustration showing the BIOS output the IPMI command request to the BMC according to a preferred embodiment of the invention.

FIG. 9 is a flow chart showing a monitoring method according to the embodiment of the invention.

### DETAILED DESCRIPTION OF THE INVENTION

A server, a computer system and a method for monitoring the computer system are provided in the following embodiment. The computer system includes a server and a remote computer. The server includes a basic input/output system (BIOS) and a base management controller (BMC), while the remote computer includes a processing unit. The BIOS executes a detection procedure to generate a status code, and the BMC outputs a management message according to the status code. The processing unit executes monitor software such that the processing unit generates a monitor message according to the management message.

### Embodiment

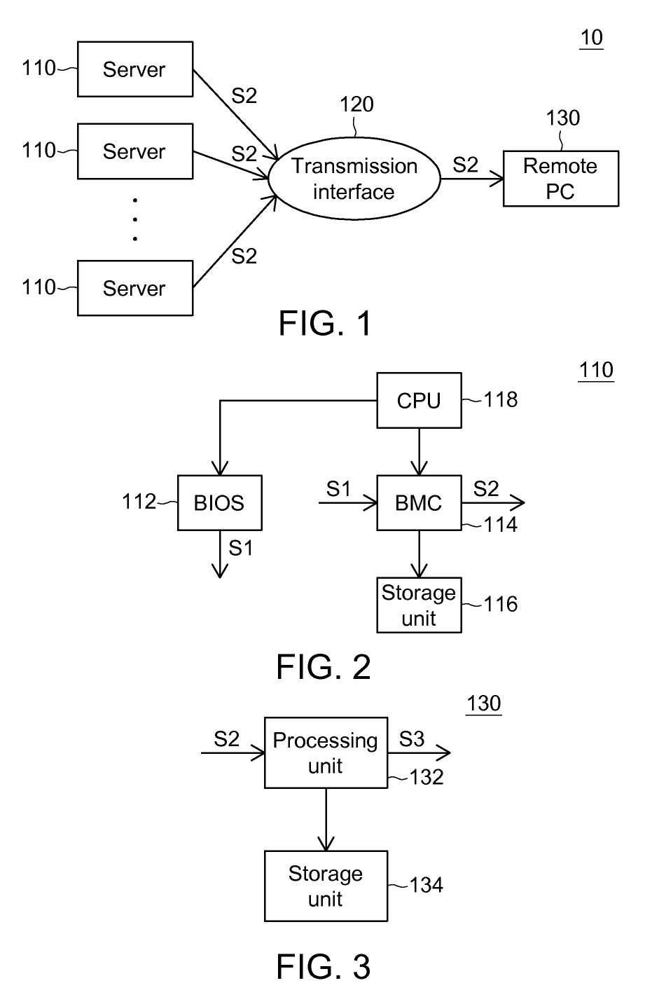

FIG. 1 shows a computer system 10 according to an embodiment of the invention. FIG. 2 is a schematic illustration showing a server according to an embodiment of the invention. FIG. 3 is a schematic illustration showing a remote computer according to an embodiment of the invention. Referring to FIGS. 1 to 3, the computer system 10 includes a server 110 and a remote computer 130. The server 110 communicates with the remote computer 130 via a transmission interface 120. For example, the transmission interface 120 may be a network interface, an RS232 interface or other interface which can communicate the server 110 with computer 130. As an example to intelligent platform management interface (IPMI), The IPMI can communicate with outside by IPMB, KCS, SMIC, BT, SSIF, LAN, UART, SOL or ICMB. The network interface may be a wired network or a wireless network.

The server 110 includes a basic input/output system (BIOS) 112, a base management controller (BMC) 114, an I/O port 116, a storage unit 117, a central processing unit (CPU) 118 and a bus 119. The remote computer 130 includes a processing unit 132 and a storage unit 134. The BIOS 112 executes a detection procedure to generate a status code S1, and the BMC 114 outputs a management message S2 according to the status code S1. The processing unit 132 executes monitor software such that the processing unit 132 generates a monitor message S3 according to the management message S2. The remote computer 130 can monitor or remote manage the server 110 by the monitor software so as to provide an image about the status of the server 110.

The server 110 adopts an intelligent platform management interface (IPMI), for example. The IPMI makes a management information system (MIS) operator be able to monitor health conditions of various components on the server 110 via IPMB, KCS, SMIC, BT, SSIF, LAN, UART, SOL, ICMB, the network or a serial transmission form, wherein the health conditions may include, for example, the operation of the CPU 118, the rotating speed of the fan, the system temperature, the voltage and the like. The MIS operator may set its sensed threshold values corresponding to the to-be-monitored portions. When the IPMI controller cannot sense the normal condition, the IPMI controller can inform the MIS operator to handle the problem. In addition, the IPMI adds the remote management and system recovery functions according to the cooperation of the hardware and the software so that the MIS operator can know, from the remote computer 130, the status of the server 110, such as shutdown, booting, OS crash, and the like, and issue various commands, such as those of boot, shutdown and re-boot. When the server 110 adopts the IPMI, the management message S2 is an IPMI command, for example.

In detail, the BIOS 112 is in charge of initializing and detecting various hardware apparatuses of the server 110 to ensure that the server 110 can work normally. The detection procedure executed by the BIOS 112 in the present embodiment is a power on self test (POST) procedure. After the BIOS 112 executing the POST procedure, a status code S1, such as a POST code or a beep code, indicating the current status of the server 110 according to the detected result of the detection procedure is outputted. The POST code is presented by one byte, while the beep code is presented by the length of the sound.

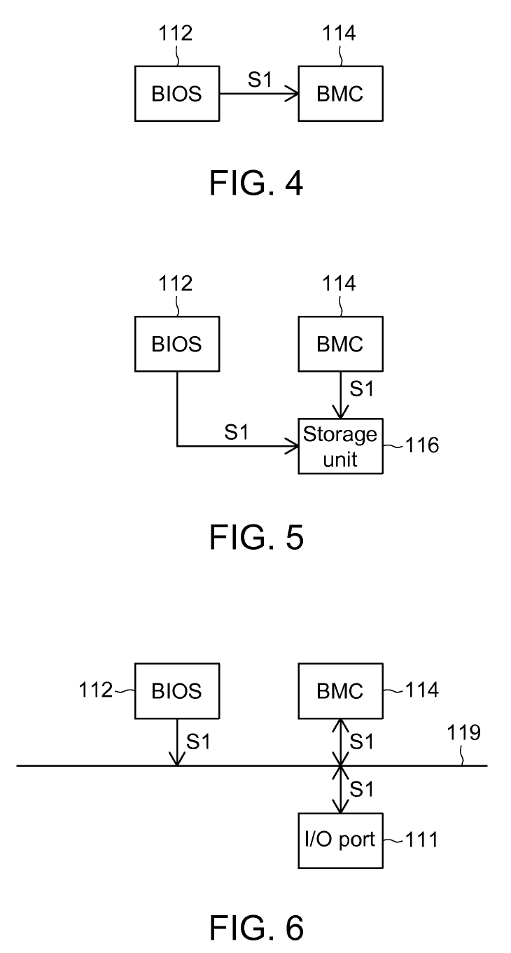

The BMC 114 may actively or passively obtain the status code S1 generated by the BIOS 112. FIG. 4 is a schematic illustration showing the BMC for passively obtaining the status code according to a preferred embodiment of the invention. When the BMC 114 obtains the status code S1 passively, the BIOS 112 directly outputs the status code S1 to the BMC 114. FIG. 5 is a schematic illustration showing the BMC for actively obtaining the status code according to a preferred embodiment of the invention. Oppositely, when the BMC 114 obtains the status code S1 actively, for example, the BIOS 112 can firstly store the status code S1 in the storage unit 116 and then the BMC 114 actively reads the status code S1 from the storage unit 116. The status code S1 is stored to the storage unit 116, and the BMC 114 reads the status code S1 by way of polling, for example.

FIG. 6 is another schematic illustration showing the BMC for actively obtaining the status code according to a preferred embodiment of the invention. The server 110 further includes an I/O port 111 and a bus 119. When the BMC 114 obtains the status code S1 actively, for example, the I/O port 111 such as port 80 receives the status code S1 from the BIOS 112 via the bus 119 such as LPC bus, PCI bus or other type of bus to transmit signals from the BIOS 112, and the BMC 114 actively monitors the I/O port 111 to get the status code S1 via the bus 119. The BMC 114 reads the status code S1 by way of polling, for example. Because the BMC 114 may obtain the status code S1 generated by the BIOS 112, it is unnecessary to additionally purchase a debug card for reading the status code S1.

In addition, the storage unit 116 may further store a look-up table for the status code S1, and the BMC 114 converts the status code S1 into the management message S2 having a meaning corresponding to the status code according to the look-up table, and outputs the management message S2 to the remote computer 130. The processing unit 132 executes the monitor software such that the processing unit 132 generates the monitor message S3 according to the management message S2 having the meaning corresponding to the status code S1. Because the management message S2 has the meaning corresponding to the status code S1, the processing unit 132 can generate an icon monitor message or a text monitor message corresponding to the meaning of the status code S1 according to the management message S2. For example, the BIOS 112 executes the detection procedure to generate the status code S1 equal to “EF”, and the BMC 114 outputs the management message S2 having the meaning of the status code according to “EF”. Because the meaning of the status code “EF” represents “video card error”, the processing unit 132 generates an icon of “video card error” or the text monitor message S3 according to the management message S2. Consequently, the MIS operator needs not to look up the look-up table in the manual way and can quickly obtain the current booting status of the server 110.

The look-up table can be stored in not only the storage unit 116 of the server 110 but also the storage unit 134 of the remote computer 130. Consequently, the BMC 114 only has to simply convert the status code S1 into the management message S2 form without the meaning of the status code and output the management message S2 to the remote computer 130. The processing unit 132 again converts the management message S2 into the icon or text monitor message S3 having the meaning of the status code S1 according to the status table of the storage unit 134.

Different basic input/output systems may have different look-up tables. So, the look-up table to be stored in the storage unit 116 or 134 may be determined in advance. Thereafter, the BMC 114 can provide the correct management message S2 according to the predetermined look-up table. Furthermore, the storage unit 116 may further store multiple look-up tables corresponding to the different basic input/output systems. The BMC 114 can dynamically select the corresponding look-up table according to the BIOS identifier (BIOS ID) S4 to fit the variety of the basic input/output system in all kinds of servers. Thus, the BMC 114 can correctly convert the status code S1 into the management message S2 having the right meaning of the status code S1 according to the selected look-up table, and the convenience of operation of the user may be greatly enhanced.

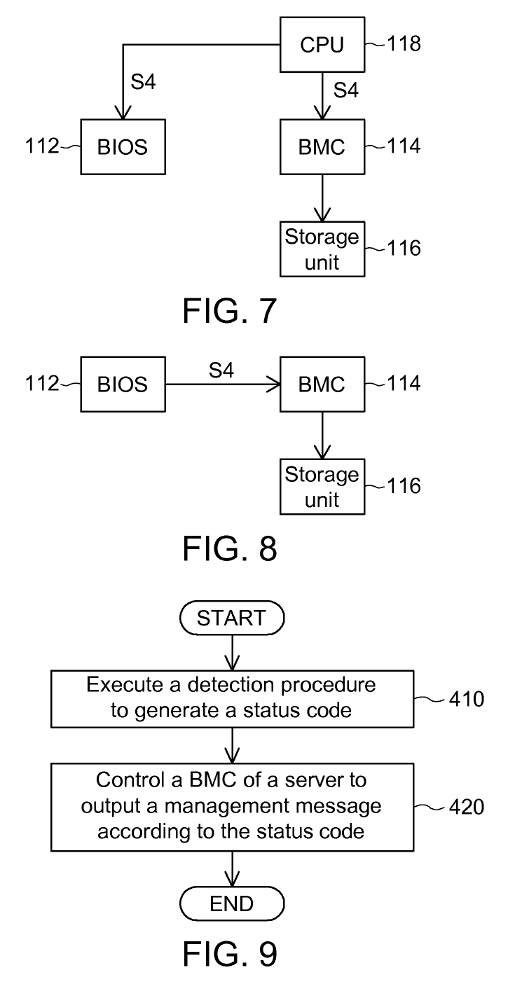

The BIOS identifier S4 is obtained in a static or dynamic manner, for example. Taking the static manner as an example, the BIOS identifier S4 is pre-stored in a field replaceable unit (FRU) or a private data field. There are at least two dynamic manners that may be adopted. FIG. 7 is a schematic illustration showing the CPU for acquiring the BIOS identifier from the BIOS according to a preferred embodiment of the invention. For instance, in the first dynamic manner, the CPU 118 actively acquires the BIOS identifier S4 from the BIOS 112, and outputs the BIOS identifier S4 to the BMC 114 via a keyboard controller style (KCS) channel. FIG. 8 is a schematic illustration showing the BIOS outputs the IPMI command request to the BMC according to a preferred embodiment of the invention. In the second dynamic manner, the BIOS 112 can output the IPMI command request to the BMC 114, wherein the IPMI command request may be, for example, an IPMI customized OEM command or an OEM field of an IPMI standard command.

Please refer to FIGS. 1 to 9 simultaneously. FIG. 9 is a flow chart showing a monitoring method according to an embodiment of the invention. The monitoring method may be applied to the computer system 10, and includes the following steps. First, as shown in step 410, the BIOS 112 executes the detection procedure to generate the status code S1. Next, as shown in step 420, the BMC 114 of the server 110 is controlled to output the management message S2 according to the status code S1.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer system, comprising:
a server, which comprises:
a basic input/output system (BIOS) for executing a detection procedure to generate a status code; and
a base management controller (BMC) for outputting a management message according to the status code; and
a remote computer, which comprises:
a processing unit for executing monitor software such that the processing unit generates a monitor message according to the management message.

2. The computer system according to claim 1, wherein the processing unit converts the management message into the monitor message having a meaning corresponding to the status code.

3. The computer system according to claim 2, wherein the remote computer further comprises:
a storage unit for storing a look-up table, wherein the processing unit converts the management message into the monitor message according to the look-up table.

4. A server, comprising:
a basic input/output system (BIOS) for executing a detection procedure to generate a status code; and
a base management controller (BMC) for outputting a management message according to the status code.

5. The server according to claim 4, further comprising:
a storage unit for storing the status code, wherein the BMC reads the status code from the storage unit.

6. The server according to claim 4, wherein the BIOS outputs the status code to the BMC.

7. The server according to claim 4, wherein the BMC converts the status code into the management message having a meaning corresponding to the status code.

8. The server according to claim 7, further comprising:
a storage unit for storing a look-up table, wherein the BMC converts the status code into the management message according to the look-up table.

9. The server according to claim 7, further comprising:
a storage unit for storing a plurality of look-up tables, wherein the BMC selects one of the look-up tables according to a BIOS identifier (BIOS ID), and converts the status code into the management message according to the selected one of the look-up tables.

10. The server according to claim 9, wherein the BIOS identifier is outputted from the BIOS to the BMC.

11. The server according to claim 4, further comprising:
a central processing unit (CPU) for retrieving a BIOS identifier from the BIOS and outputting the BIOS identifier to the BMC.

12. The server according to claim 4, wherein the status code is a power on self test (POST) code.

13. The server according to claim 4, wherein the status code is a beep code.

14. The server according to claim 4, wherein the management message is an intelligent platform management interface (IPMI) command.

15. The server according to claim 4, further comprising:
a I/O port for receiving the status code from the BIOS, wherein the BMC monitors the I/O port to get the status code.

16. A monitoring method of a computer, the method comprising the steps of:
executing a detection procedure to generate a status code; and
controlling a base management controller (BMC) of the server to output a management message according to the status code.

17. The method according to claim 16, further comprising the steps of:
storing the status code to a storage unit of the server; and
reading the status code from the storage unit.

18. The method according to claim 16, further comprising the step of:
outputting the status code to the BMC.

19. The method according to claim 16, wherein the step of controlling comprises:
controlling the BMC to convert the status code into the management message having a meaning corresponding to the status code; and
controlling the BMC to output the management message.

20. The method according to claim 19, wherein controlling the BMC to output the management message according to the status message comprises:
storing a look-up table to a storage unit of the server; and
controlling the BMC to convert the status code into the management message according to the look-up table.

21. The method according to claim 19, wherein controlling the BMC to output the management message according to the status message comprises:
storing a plurality of look-up tables to a storage unit of the server;
selecting one of the look-up tables according to a basic input/output system identifier (BIOS ID); and
controlling the BMC to convert the status code into the management message according to the selected one of the look-up tables.
